(19) United States
(12) Patent Application Publication
(10) Pub. No.: US 2025/0056065 A1
(43) Pub. Date: Feb. 13, 2025

(54) METHOD, DEVICE, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Kai ZHANG, Los Angeles, CA (US); Li ZHANG, Los Angeles, CA (US); Zhipin DENG, Beijing (CN); Na ZHANG, Beijing (CN); Yang WANG, Beijing (CN)

(73) Assignees: Beijing Bytedance Network Technology Co., Ltd., Beijing (CN); Bytedance Inc., Los Angeles, CA (US)

(21) Appl. No.: 18/289,975

(22) PCT Filed: May 12, 2022
(86) PCT No.: PCT/CN2022/092462

§ 371 Date: Nov. 8, 2023

(30) Foreign Application Priority Data
May 13, 2021 (WO) PCT/CN2021/093653

(51) Int. Cl. H04N 19/86; H04N 19/52

(52) U.S. Cl. CPC H04N 19/86; H04N 19/52

(57) ABSTRACT

Embodiments of the present disclosure provide a solution for video processing. A method for video processing is proposed. The method comprises: determining, during a conversion between a current video block of a video and a bitstream of the video, whether coding information of a reference video block is used to code a first piece of motion information of the current video block based on a coding pattern applied to the reference video block; and performing the conversion based on the determining. The method in accordance with the first aspect of the present disclosure improves the coding process of the current video block. Compared with the conventional solution, the proposed method can advantageously improve the coding efficiency and avoid the undesirable latency.

### FIELD

Embodiments of the present disclosure relates generally to video coding techniques, and more particularly, to refinement in image or video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a current video block of a video and a bitstream of the video, whether coding information of a reference video block is used to code a first piece of motion information of the current video block based on a coding pattern applied to the reference video block; and performing the conversion based on the determining. The method in accordance with the first aspect of the present disclosure improves the coding process of the current video block. Compared with the conventional solution, the proposed method can advantageously improve the coding efficiency and avoid the undesirable latency.

In a second aspect, a method for video processing is proposed. The method comprises: determining, during a conversion between a current video block of a video and a bitstream of the video, whether a template-based process is applied to the current video block based on coding information of the current video block or coding information of at least one neighboring video block of the current video block; and performing the conversion based on the refinement process. The method in accordance with the second aspect of the present disclosure improves the template-based process. Compared with the conventional solution, the proposed method can advantageously improve the coding efficiency and avoid the undesirable latency.

In a third aspect, an apparatus for video processing is proposed. The apparatus comprises a processor and a non-transitory memory coupled to the processor and having instructions stored thereon, wherein the instructions upon execution by the processor, cause the processor to: determine, during a conversion between a current video block of a video and a bitstream of the video, whether coding information of a reference video block is used to code a first piece of motion information of the current video block based on a coding pattern applied to the reference video block; and perform the conversion based on the determining.

In a fourth aspect, an apparatus for video processing is proposed. The apparatus comprises a processor and a non-transitory memory coupled to the processor and having instructions stored thereon, wherein the instructions upon execution by the processor, cause the processor to: determine, during a conversion between a current video block of a video and a bitstream of the video, whether a template-based process is applied to the current video block based on coding information of the current video block or coding information of at least one neighboring video block of the current video block; and perform the conversion based on the refinement process.

In a fifth aspect, a non-transitory computer-readable storage medium is proposed. The non-transitory computer-readable storage medium storing instructions that cause a processor to perform a method in accordance with the first aspect of the present disclosure.

In a sixth aspect, a non-transitory computer-readable storage medium is proposed. The non-transitory computer-readable storage medium storing instructions that cause a processor to perform a method in accordance with the second aspect of the present disclosure.

In a seventh aspect, a non-transitory computer-readable recording medium is proposed. The non-transitory computer-readable recording medium storing a bitstream of a video which is generated by a method performed by an apparatus for video processing, wherein the method comprises: determining whether coding information of a reference video block is used to code a first piece of motion information of the current video block based on a coding pattern applied to the reference video block; and generating the bitstream based on the determining.

In an eighth aspect, a non-transitory computer-readable recording medium is proposed. The non-transitory computer-readable recording medium storing a bitstream of a video which is generated by a method performed by an apparatus for video processing, wherein the method comprises: determining whether a template-based process is applied to the current video block based on coding information of the current video block or coding information of at least one neighboring video block of the current video block; and generating the bitstream based on the determining.

In a ninth aspect, a method for storing a bitstream of a video is proposed. The method comprises: determining whether coding information of a reference video block is used to code a first piece of motion information of the current video block based on a coding pattern applied to the reference video block; generating the bitstream based on the determining; and storing the bitstream in a non-transitory computer-readable recording medium.

In a tenth aspect, a method for storing a bitstream of a video is proposed. The method comprises: determining whether a template-based process is applied to the current video block based on coding information of the current video block or coding information of at least one neighboring video block of the current video block; generating the bitstream based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 is a schematic diagram illustrating positions of a spatial merge candidate;

FIG. 5 is a schematic diagram illustrating candidate pairs considered for redundancy check of spatial merge candidates;

FIG. 6 illustrates motion vector scaling for temporal merge candidate;

FIG. 7 is a schematic diagram illustrating candidate positions for temporal merge candidate, C0 and C1;

FIG. 8 is a schematic diagram illustrating a merge mode with motion vector differences (MMVD) search point;

FIG. 9 is a schematic diagram illustrating the decoding side motion vector refinement;

FIG. 10 illustrates examples of the geometric partitioning mode (GPM) splits grouped by identical angles;

FIG. 11 is a schematic diagram illustrating the uni-prediction motion vector (MV) selection for geometric partitioning mode;

FIG. 12 is a schematic diagram illustrating the exemplified generation of a bending weight Wo using GPM;

FIG. 13 is a schematic diagram illustrating bilateral matching;

FIG. 14 is a schematic diagram illustrating the template matching;

FIG. 15 is a schematic diagram illustrating unilateral motion estimation (ME) in Frame Rate Up Conversion (FRUC);

FIG. 16 is a schematic diagram illustrating neighboring samples used for calculating SA;

FIG. 17 is a schematic diagram illustrating neighboring samples used for calculating SAD for sub-CU level motion information;

FIG. 18 is a schematic diagram illustrating sorting process;

FIG. 19 is a schematic diagram illustrating local illumination compensation;

FIG. 20 is a schematic diagram illustrating no subsampling for the short side;

FIG. 21 is a schematic diagram illustrating costing a hypothesis reconstructed border;

FIG. 22 is a schematic diagram illustrating proposed intra block decoding process;

FIG. 23 is a schematic diagram illustrating histogram of gradient (HoG) computation from a template of width 3 pixels;

FIG. 24 is a schematic diagram illustrating prediction fusion by weighted averaging of two HoG modes and planar;

FIG. 25 illustrates a flowchart of a method for video processing in accordance with some embodiments of the present disclosure;

FIG. 26 illustrates a flowchart of a method for video processing in accordance with some embodiments of the present disclosure; and

FIG. 27 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

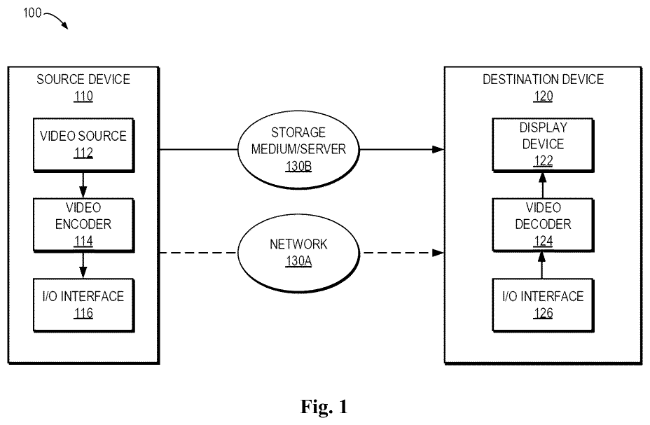

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to the destination device 120 via the I/O interface 116 through a network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or future standards.

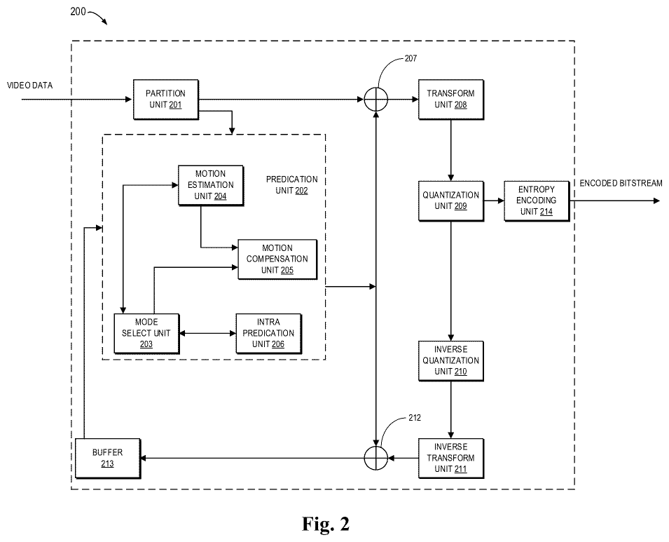

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode selection unit 203, a motion estimation unit 204, a motion compensation unit 205 and an intra prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and a video decoder 300 (which will be discussed in detail below) may support various video block sizes.

The mode selection unit 203 may select one of the coding modes, intra or inter, e.g., based on error results, and provide the resulting intra-coded or inter-coded block to the residual generation unit 207 to generate residual block data and to the reconstruction unit 212 to reconstruct the encoded block for use as a reference picture. In some examples, the mode selection unit 203 may select a combination of intra and inter predication (CIIP) mode in which the predication is based on an inter predication signal and an intra predication signal. The mode selection unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, the video encoder 200 may predictively signal the motion vector. Two examples of predictive signaling techniques that may be implemented by the video encoder 200 include advanced motion vector predication (AMVP) and merge mode signaling.

The intra prediction unit 206 may perform intra prediction on the current video block. When performing intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform unit 208 may generate one or more transform coefficient video blocks for the current video block by applying one or more transforms to a residual video block associated with the current video block.

After the transform unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, a loop filtering operation may be performed to reduce video blocking artifacts in the video block.

The entropy encoding unit 214 may receive data from other functional components of the video encoder 200. When the data is received, the entropy encoding unit 214 may perform one or more entropy encoding operations to generate entropy encoded data and output a bitstream that includes the entropy encoded data.

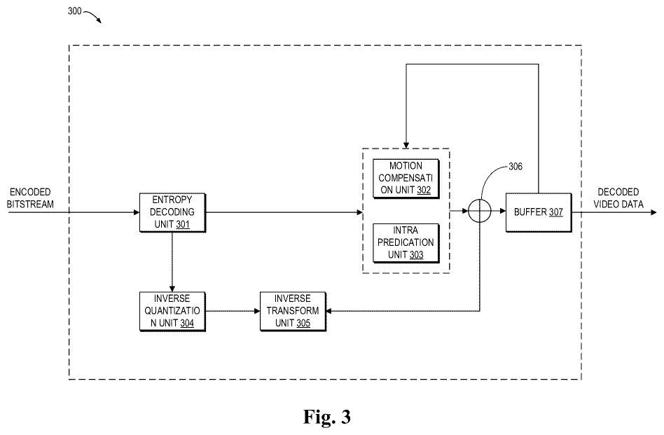

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transform unit 305, a reconstruction unit 306, and a buffer 307. The video decoder 300 may, in some examples, perform a decoding pass that is generally reciprocal to the encoding pass as described with respect to the video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes, which, for example, are received in the bitstream, to form a prediction block from spatially adjacent blocks. The inverse quantization unit 304 inverse quantizes, i.e., de-quantizes, the quantized video block coefficients provided in the bitstream and decoded by the entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some example embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video coding technologies. Specifically, it is about inter prediction and related techniques in video coding. It may be applied to the existing video coding standard like HEVC, VVC, etc. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards (ITU-T and ISO/IEC, “High efficiency video coding”, Rec. ITU-T H.265|ISO/IEC 23008-2 (in force edition)). Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Embodiments of Coding Tools

### 2.1.1. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1.1. Spatial Candidates Derivation

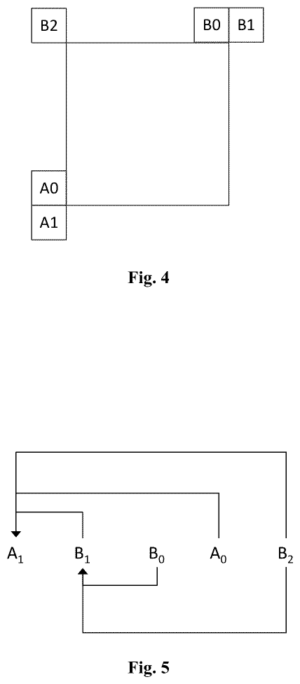

The derivation of spatial merge candidates in VVC is same to that in HEVC except the positions of first two merge candidates are swapped. A maximum of four merge candidates are selected among candidates located in the positions depicted in FIG. 4. The order of derivation is B0, A0, B1, A1 and B2. Position B2 is considered only when one or more than one CUs of position B0, A0, B1, A1 are not available (e.g., because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 5 are considered and a candidate is only added to the list if the corresponding candidate used for redundancy check has not the same motion information.

### 2.1.1.2. Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C0 and C1, as depicted in FIG. 7. If CU at position C0 is not available, is intra coded, or is outside of the current row of CTUs, position C1 is used. Otherwise, position C0 is used in the derivation of the temporal merge candidate.

### 2.1.1.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:

Number of HMPV candidates is used for merge list generation is set as (N<=4)? M: (8−N), wherein N indicates number of existing candidates in the merge list and M indicates number of available HMVP candidates in the table.

Once the total number of available merge candidates reaches the maximally allowed merge candidates minus 1, the merge candidate list construction process from HMVP is terminated.

### 2.1.1.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.1.1.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

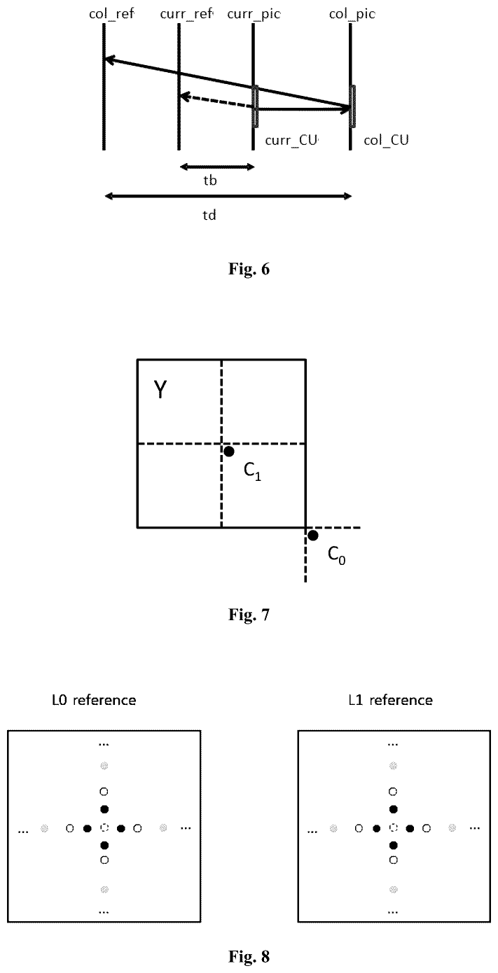

Distance index specifies motion magnitude information and indicate the pre-defined offset from the starting point. As shown in FIG. 8, an offset is added to either horizontal component or vertical component of starting MV. The relation of distance index and pre-defined offset is specified in Table 1

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e., POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2 specifies the sign of MV offset added to the list0 MV component of starting MV and the sign for the list1 MV has opposite value.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.1.3. Decoder Side Motion Vector Refinement (DMVR)

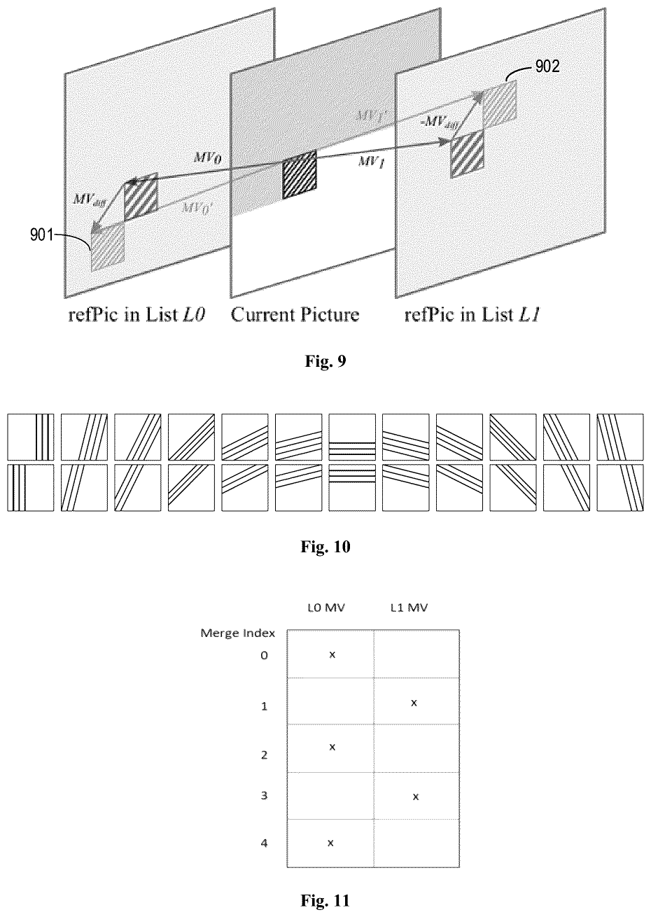

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 9, the SAD between the blocks 901 and 902 based on each MV candidate around the initial MV is calculated. The MV candidate with the lowest SAD becomes the refined MV and used to generate the bi-predicted signal.

In VVC, the DMVR can be applied for the CUS which are coded with following modes and features:
CU level merge mode with bi-prediction MV
One reference picture is in the past and another reference picture is in the future with respect to the current picture
The distances (i.e., POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

2.1.3.1. Searching scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$M V 0 , = M V 0 + MV\_offset \qquad ( 1 )$$

$$MV 1 , = M V 1 - MV\_offset \qquad ( 2 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 3 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 4 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 5 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.3.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.3.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.4. Geometric Partitioning Mode (GPM) for Inter Prediction

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m,n∈{3 . . . 6} excluding 8×64 and 64×8.

When this mode is used, a CU is split into two parts by a geometrically located straight line (FIG. 10). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.2. This is the prediction signal for the whole CU, and transform and quantization process will be applied to the whole CU as in other prediction modes. Finally, the motion field of a CU predicted using the geometric partition modes is stored as in 3.4.3.

### 2.1.4.1. Uni-Prediction Candidate List Construction

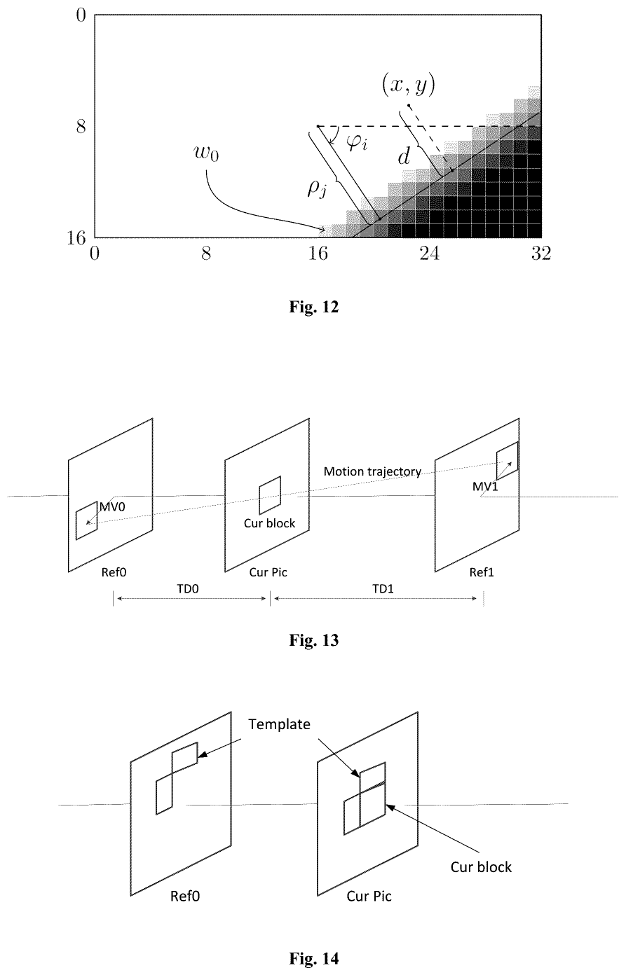

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 11. In case a corresponding LX motion vector of the n-the extended merge candidate does not exist, the L(1−X) motion vector of the same candidate is used instead as the uni-prediction motion vector for geometric partitioning mode.

### 2.1.4.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 6 )$$

$${ρ}_{j} = {ρ}_{x , j} cos ( {φ}_{i} ) + {ρ}_{y , j} s in ( {φ}_{i} ) \qquad ( 7 )$$

$${ρ}_{x , j} = \{ \begin{matrix}0 & i \%16 = 8 or ( i \%16 \neq 0 and h \geq w ) \\ \pm ( j \times w ) ≫ 2 & otherwise\end{matrix} \qquad ( 8 )$$

$${ρ}_{y , j} = \{ \begin{matrix}\pm ( j \times w ) ≫ 2 & i \%16 = 8 or ( i \%16 \neq 0 and h \geq w ) \\ 0 & otherwise\end{matrix} \qquad ( 9 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 10 )$$

$${w}_{0} ( x , y ) = \frac{Clip 3 ( 0 , 8 , ( wIdxL ( x , y ) + 4 ) ≫ 3 )}{8} \qquad ( 11 )$$

$${w}_{1} ( x , y ) = 1 - {w}_{0} ( x , y ) \qquad ( 12 )$$

The partIdx depends on the angle index i. One example of weigh w₀ is illustrated in FIG. 12.

### 2.1.4.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = {abs}_{( m o t i o n l d x )} < 32 ? 2 {:}_{( motionIdx \leq 0 ? ( 1 - partIdx ) : partIdx )} \qquad ( 13 )$$

where motionIdx is equal to d(4x+2, 4y+2). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   2.2. Geometric Prediction Mode with Motion Vector Differences (GMVD)

Geometric prediction mode with Motion Vector Difference (GMVD) is proposed. With GMVD, each geometric partition in GPM can decide to use GMVD or not. If GMVD is chosen for a geometric region, the MV of the region is calculated as a sum of the MV of a merge candidate and an MVD. All other processing is kept the same as in GPM.

With GMVD, an MVD is signaled as a pair of direction and distance, following the current design of MMVD. That is, there are eight candidate distances (¼-pel, ½-pel, 1-pel, 2-pel, 4-pel, 8-pel, 16-pel, 32-pel), and four candidate directions (toward-left, toward-right, toward-above, and toward-below). In addition, when pic_fpel_mmvd_enabled_flag is equal to 1, the MVD in GMVD is also left shifted by 2 as in MMVD.

### 2.3. Frame Rate Up Conversion (FRUC) in JEM

A FRUC flag is signalled for a CU when its merge flag is true. When the FRUC flag is false, a merge index is signalled and the regular merge mode is used. When the FRUC flag is true, an additional FRUC mode flag is signalled to indicate which method (bilateral matching or template matching) is to be used to derive motion information for the block.

At encoder side, the decision on whether using FRUC merge mode for a CU is based on RD cost selection as done for normal merge candidate. That is the two matching modes (bilateral matching and template matching) are both checked for a CU by using RD cost selection. The one leading to the minimal cost is further compared to other CU modes. If a FRUC matching mode is the most efficient one. FRUC flag is set to true for the CU and the related matching mode is used.

Motion derivation process in FRUC merge mode has two steps. A CU-level motion search is first performed, then followed by a Sub-CU level motion refinement. At CU level, an initial motion vector is derived for the whole CU based on bilateral matching or template matching. First, a list of MV candidates is generated and the candidate which leads to the minimum matching cost is selected as the starting point for further CU level refinement. Then a local search based on bilateral matching or template matching around the starting point is performed and the MV results in the minimum matching cost is taken as the MV for the whole CU. Subsequently, the motion information is further refined at sub-CU level with the derived CU motion vectors as the starting points.

For example, the following derivation process is performed for a W×H CU motion information derivation. At the first stage, MV for the whole W×H CU is derived. At the second stage, the CU is further split into M×M sub-CUs. The value of M is calculated as in (16), D is a predefined splitting depth which is set to 3 by default in the JEM. Then the MV for each sub-CU is derived.

$$M = max \{ 4 , min \{ \frac{M}{{2}^{D}} , \frac{N}{{2}^{D}} \} \} \qquad ( 13 )$$

As shown in the FIG. 13, the bilateral matching is used to derive motion information of the current CU by finding the closest match between two blocks along the motion trajectory of the current CU in two different reference pictures. Under the assumption of continuous motion trajectory, the motion vectors MV0 and MV1 pointing to the two reference blocks shall be proportional to the temporal distances, i.e., TD0 and TD1, between the current picture and the two reference pictures. As a special case, when the current picture is temporally between the two reference pictures and the temporal distance from the current picture to the two reference pictures is the same, the bilateral matching becomes mirror based bi-directional MV.

As shown in FIG. 14, template matching is used to derive motion information of the current CU by finding the closest match between a template (top and/or left neighbouring blocks of the current CU) in the current picture and a block (same size to the template) in a reference picture. Except the aforementioned FRUC merge mode, the template matching is also applied to AMVP mode. In the JEM, as done in HEVC, AMVP has two candidates. With template matching method, a new candidate is derived. If the newly derived candidate by template matching is different to the first existing AMVP candidate, it is inserted at the very beginning of the AMVP candidate list and then the list size is set to two (meaning remove the second existing AMVP candidate). When applied to AMVP mode, only CU level search is applied.

### CU Level MV Candidate Set

The MV candidate set at CU level consists of:
(i) Original AMVP candidates if the current CU is in AMVP mode
(ii) all merge candidates,
(iii) several MVs in the interpolated MV field (described later).
(iv) top and left neighbouring motion vectors

When using bilateral matching, each valid MV of a merge candidate is used as an input to generate a MV pair with the assumption of bilateral matching. For example, one valid MV of a merge candidate is (MVa, refa) at reference list A. Then the reference picture refb of its paired bilateral MV is found in the other reference list B so that refa and refb are temporally at different sides of the current picture. If such a refb is not available in reference list B, refb is determined as a reference which is different from refa and its temporal distance to the current picture is the minimal one in list B. After refb is determined, MVb is derived by scaling MVa based on the temporal distance between the current picture and refa, refb.

Four MVs from the interpolated MV field are also added to the CU level candidate list. More specifically, the interpolated MVs at the position (0, 0), (W/2, 0), (0, H/2) and (W/2, H/2) of the current CU are added.

When FRUC is applied in AMVP mode, the original AMVP candidates are also added to CU level MV candidate set.

At the CU level, up to 15 MVs for AMVP CUs and up to 13 MVs for merge CUs are added to the candidate list.

### Sub-CU Level MV Candidate Set

The MV candidate set at sub-CU level consists of:
(i) an MV determined from a CU-level search,
(ii) top, left, top-left and top-right neighbouring MVs,
(iii) scaled versions of collocated MVs from reference pictures,
(iv) up to 4 ATMVP candidates,
(v) up to 4 STMVP candidates

The scaled MVs from reference pictures are derived as follows. All the reference pictures in both lists are traversed. The MVs at a collocated position of the sub-CU in a reference picture are scaled to the reference of the starting CU-level MV.

ATMVP and STMVP candidates are limited to the four first ones.

At the sub-CU level, up to 17 MVs are added to the candidate list.

### Generation of Interpolated MV Field

Before coding a frame, interpolated motion field is generated for the whole picture based on unilateral ME. Then the motion field may be used later as CU level or sub-CU level MV candidates.

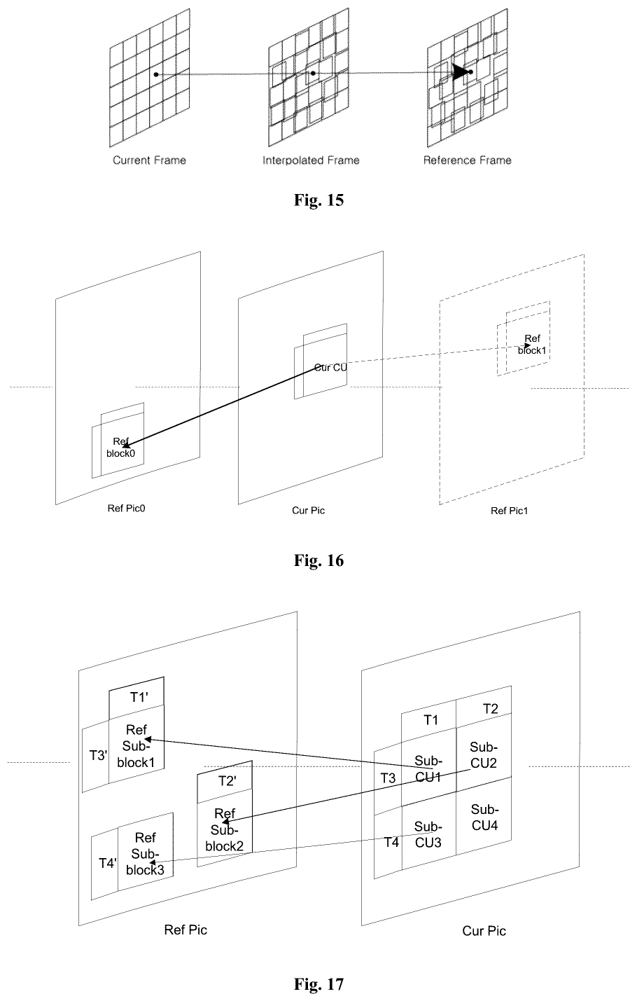

First, the motion field of each reference pictures in both reference lists is traversed at 4×4 block level. For each 4×4 block, if the motion associated to the block passing through a 4×4 block in the current picture (as shown in FIG. 15) and the block has not been assigned any interpolated motion, the motion of the reference block is scaled to the current picture according to the temporal distance TD0 and TD1 (the same way as that of MV scaling of TMVP in HEVC) and the scaled motion is assigned to the block in the current frame. If no scaled MV is assigned to a 4×4 block, the block's motion is marked as unavailable in the interpolated motion field.

### Interpolation and Matching Cost

When a motion vector points to a fractional sample position, motion compensated interpolation is needed. To reduce complexity, bi-linear interpolation instead of regular 8-tap HEVC interpolation is used for both bilateral matching and template matching.

The calculation of matching cost is a bit different at different steps. When selecting the candidate from the candidate set at the CU level, the matching cost is the absolute sum difference (SAD) of bilateral matching or template matching. After the starting MV is determined, the matching cost C of bilateral matching at sub-CU level search is calculated as follows:

$$C = S A D + w \cdot ( \vert {MV}_{x} - M {V}_{x}^{s} \vert + \vert {MV}_{y} - M {V}_{y}^{s} \vert ) \qquad ( 14 )$$

where w is a weighting factor which is empirically set to 4, MV and MVS indicate the current MV and the starting MV, respectively. SAD is still used as the matching cost of template matching at sub-CU level search.

In FRUC mode, MV is derived by using luma samples only. The derived motion will be used for both luma and chroma for MC inter prediction. After MV is decided, final MC is performed using 8-taps interpolation filter for luma and 4-taps interpolation filter for chroma.

### MV Refinement

MV refinement is a pattern based MV search with the criterion of bilateral matching cost or template matching cost. In the JEM, two search patterns are supported—an unrestricted center-biased diamond search (UCBDS) and an adaptive cross search for MV refinement at the CU level and sub-CU level, respectively. For both CU and sub-CU level MV refinement, the MV is directly searched at quarter luma sample MV accuracy, and this is followed by one-eighth luma sample MV refinement. The search range of MV refinement for the CU and sub-CU step are set equal to 8 luma samples.

### Selection of Prediction Direction in Template Matching FRUC Merge Mode

In the bilateral matching merge mode, bi-prediction is always applied since the motion information of a CU is derived based on the closest match between two blocks along the motion trajectory of the current CU in two different reference pictures. There is no such limitation for the template matching merge mode. In the template matching merge mode, the encoder can choose among uni-prediction from list0, uni-prediction from list1 or bi-prediction for a CU. The selection is based on a template matching cost as follows:

```
If costBi < = factor * min (cost0, cost1)
  bi-prediction is used;
Otherwise, if cost0 <= cost1
  uni-prediction from list0 is used;
Otherwise,
  uni-prediction from list1 is used;
```

where cost0 is the SAD of list0 template matching, cost1 is the SAD of list1 template matching and costBi is the SAD of bi-prediction template matching. The value of factor is equal to 1.25, which means that the selection process is biased toward bi-prediction.

The inter prediction direction selection is only applied to the CU-level template matching process.

### 2.4. Template Matching Based Adaptive Merge Candidate Reorder

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group.

The template matching cost is measured by the SAD (Sum of absolute differences) between the neighbouring samples of the current CU and their corresponding reference samples. If a merge candidate includes bi-predictive motion information, the corresponding reference samples are the average of the corresponding reference samples in reference list0 and the corresponding reference samples in reference list1, as illustrated in FIG. 16. If a merge candidate includes sub-CU level motion information, the corresponding reference samples consist of the neighbouring samples of the corresponding reference sub-blocks, as illustrated in FIG. 17.

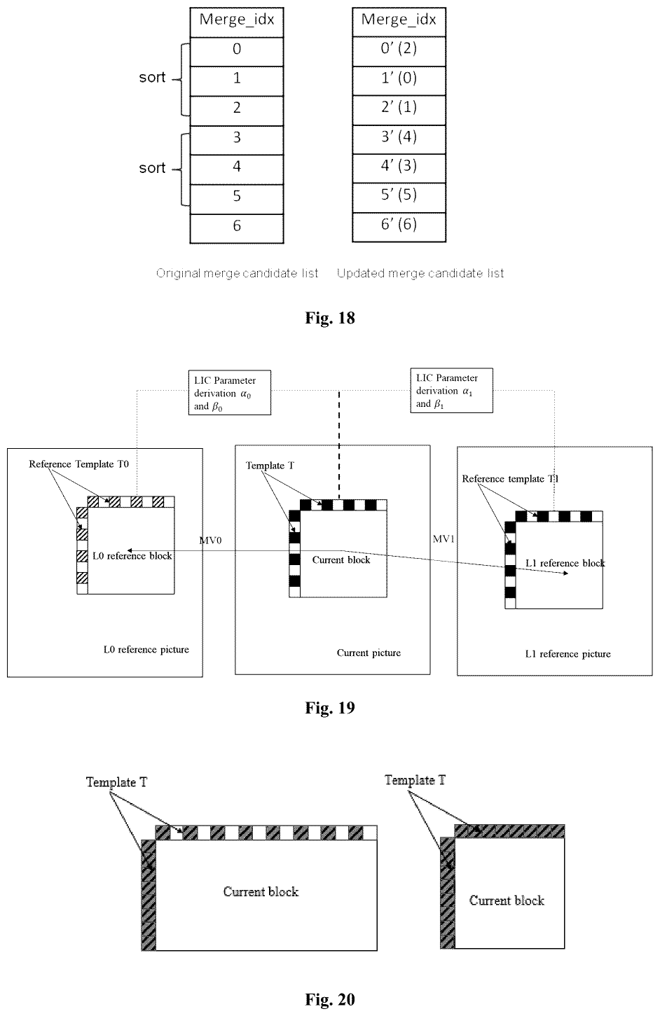

The sorting process is operated in the form of sub-group, as illustrated in FIG. 18. The first three merge candidates are sorted together. The following three merge candidates are sorted together.

The template size (width of the left template or height of the above template) is 1. The sub-group size is 3.

### 2.5. Local Illumination Compensation (LIC)

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x,y) is the prediction signal of the current block at the coordinate (x,y); Pᵣ (x+vₓ,y+v_{y}) is the reference block pointed by the motion vector (vₓ,v_{y}); α and β are the corresponding scaling factor and offset that are applied to the reference block. FIG. 19 illustrates the LIC process. In FIG. 19, when the LIC is applied for a block, a least mean square error (LMSE) method is employed to derive the values of the LIC parameters (i.e., α and β) by minimizing the difference between the neighboring samples of the current block (i.e., the template T in FIG. 19) and their corresponding reference samples in the temporal reference pictures (i.e., either T0 or T1 in FIG. 19). Additionally, to reduce the computational complexity, both the template samples and the reference template samples are subsampled (adaptive subsampling) to derive the LIC parameters, i.e., only the shaded samples in FIG. 19 are used to derive α and β.

To improve the coding performance, no subsampling for the short side is performed as shown in FIG. 20.

### 2.6. Sign Prediction

This contribution proposes a method of prediction for the signs of luma residual coefficients. A number of signs per TU can be predicted, limited by a configuration parameter and the number of coefficients present. When predicting n signs in a TU, the encoder and decoder perform n+1 partial inverse transformations and 2ⁿ border reconstructions corresponding to the 2ⁿ sign combination hypotheses, with a border-cost measure for each. These costs are examined to determine sign prediction values, and the encoder transmits a sign residual for each predicted sign indicating whether the prediction for that sign is correct or not using two additional CABAC contexts. The decoder reads these sign residuals and later uses them during reconstruction to determine the correct signs to apply after making its own predictions.

### 2.6.1. Encoder

Prior to encoding coefficients in a TU, the encoder now determines which signs to predict, and predicts them. Hypothesis processing as described below is performed during RDO decision making. The prediction results (correct or incorrect, per sign being predicted) are stored in the CU for use in later encoding.

During the final encoding stage, this stored data is used to reproduce the final bitstream containing sign residues.

### 2.6.2. Hypothesis Generation

The encoder initially dequantizes the TU and then chooses n coefficients for which signs will be predicted. The coefficients are scanned in raster-scan order, and dequantized values over a defined threshold are preferred over values lower than that threshold when collecting the n coefficients to treat.

With these n values, 2ⁿ simplified border reconstructions are performed as described below, one reconstruction per unique combination of signs for the n coefficients.

For a particular reconstruction, only the leftmost and topmost pixels of the block are recreated from the inverse transformation added to the block prediction. Although the first (vertical) inverse transform is complete, the second (horizontal) inverse transform only has to create the leftmost and topmost pixel outputs and is thus faster. An additional flag, “topLeft”, has been added to inverse transform functions to allow this.

In addition, the number of inverse transform operations performed is reduced by using a system of ‘templates’. In this way, when predicting n signs in a block, only n+1 inverse transform operations are performed:
1. A single inverse transform operating on the dequantized coefficients, where the values of all signs being predicted are set positive. Once added to the prediction of the current block, this corresponds to the border reconstruction for the first hypothesis.
2. For each of the n coefficients having their signs predicted, an inverse transform operation is performed on an otherwise empty block containing the corresponding dequantized (and positive) coefficient as its only non-null element. The leftmost and topmost border values are saved in what is termed a ‘template’ for use during later reconstructions.

Border reconstruction for a later hypothesis starts by taking an appropriate saved reconstruction of a previous hypothesis which only needs a single predicted sign to be changed from positive to negative in order to construct the desired current hypothesis. This change of sign is then approximated by the doubling and subtraction from the hypothesis border of the template corresponding to the sign being predicted. The border reconstruction, after costing, is then saved if it is known to be reused for constructing later hypotheses.

| Template Name | How to Create |
|---|---|
| T001 | inv xform single + ve 1^{st} sign-hidden coeff |
| T010 | inv xform single + ve 2^{nd} sign-hidden coeff |
| T100 | inv xform single + ve 3^{rd} sign-hidden coeff |

| Hypothesis | How to Create | Store for later reuse as |
|---|---|---|
| H000 | inv xform all coeffs | H000 |
| | add to pred | |
| H001 | H000 − 2*T001 | |
| H010 | H000 − 2*T010 | H010 |
| H011 | H010 − 2*T001 | |
| H100 | H000 − 2*T100 | H100 |
| H101 | H100 − 2*T001 | |
| H110 | H100 − 2*T010 | H110 |
| H111 | H110 − 2*T001 | |

Table showing save/restore and template application for 3 sign 8 entry case

Note that these approximations are used only during the process of sign prediction, not during final reconstruction.

### 2.6.3. Hypothesis Costing

There is a cost associated with each hypothesis that corresponds to the concept of image continuity at the block border. It is by minimizing this cost that sign prediction values are found.

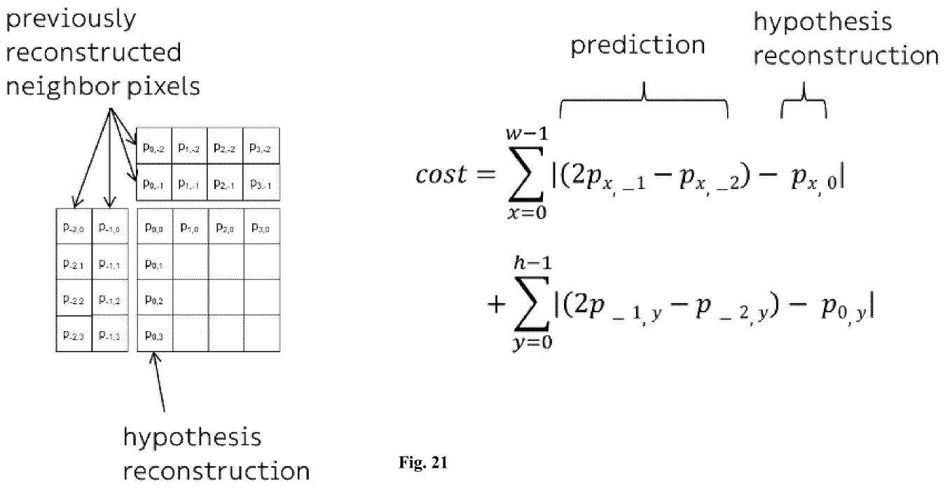

As shown in FIG. 21, for each reconstructed pixel p_{0,y} at the LHS of the reconstructed block, a simple linear prediction using the two pixels to the left is performed to get its prediction pred_{0,y}=(2p_{-1,y}−p_{-2,y}). The absolute difference between this prediction and the reconstructed pixel p_{0,y} is added to the cost of the hypothesis.

Similar processing occurs for pixels in the top row of the reconstructed block, summing the absolute differences of each prediction pred_{x,0}=(2p_{x,-1}−p_{x,-2}) and reconstructed pixel p_{x,0}.

### 2.6.4. Prediction of Multiple Signs

For each sign to be predicted, the encoder searches for the hypothesis having the lowest cost that agrees with the true values of the signs already transmitted. (Initially, with no sign residues transmitted, this simply corresponds to the lowest cost hypothesis.) The predicted value of the current sign is taken from this hypothesis.

If the prediction corresponds to the true value of the sign, a “0” is sent as the sign residue, otherwise a “1” is sent.

### 2.6.5. Final Signaling

One of two CABAC contexts are used when signaling a particular sign prediction residue. The CABAC context to use is determined by whether or not the associated dequantized coefficient is lower or higher than a threshold. Prediction residues for higher-valued coefficients are sent through a CABAC context initialized to expect a higher probability of a correct prediction (ie, a higher probability of expecting a zero residue). The current context initializations are around 58% (lower than threshold) and 74% (equal to or higher than threshold).

### 2.6.6. Other Bitstream Changes

It should be noted that as part of the software modifications applied to JEM3, the signaling of signs of all coefficients (luma, chroma, predicted and non-predicted) has been moved to the end of the TU block. I.e., signs are no longer signaled per CG. This is necessary for luma as will be seen below: the decoder needs access to all coefficient values in the TU in order to determine the signs that are predicted and that, accordingly, have only their prediction residues in the bitstream.

Although not strictly necessary for chroma as signs are never predicted for chroma, moving chroma signs to the end of the TU avoids the necessity of two different logic paths.

### 2.6.7. Decoder

### 2.6.7.1. Parsing

The decoder, as part of its parsing process, parses coefficients, signs and sign residues. The signs and sign residues are parsed at the end of the TU, and at that time the decoder knows the absolute values of all coefficients. Thus it can determine what signs are predicted and, for each predicted sign, it can determine the context to use to parse the sign prediction residue based on the dequantized coefficient value.

The knowledge of a “correct” or “incorrect” prediction is simply stored as part of the CU data of the block being parsed. The real sign of the coefficient is not known at this point.

### 2.6.7.2. Reconstruction

Later, during reconstruction, the decoder performs operations similar to the encoder (as described above for the encoder during its RDO). For n signs being predicted in the TU, the decoder performs n+1 inverse transform operations, and 2ⁿ border reconstructions to determine hypothesis costs.

The real sign to apply to a coefficient that has had its sign predicted is determined by an exclusive-or operation on:
1. The predicted value of the sign.
2. The “correct” or “incorrect” data stored in the CU during bitstream parsing.
   2.6.8. Interaction with Sign Data Hiding

In each TU where the sign of a coefficient is “hidden” using the existing Sign Data Hiding mechanism, sign prediction simply treats such coefficient as “not available” for its own prediction technique and it will predict only using others.

### 2.7. Decoder-Side Intra Mode Derivation (DIMD)

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.7.1. Signalling

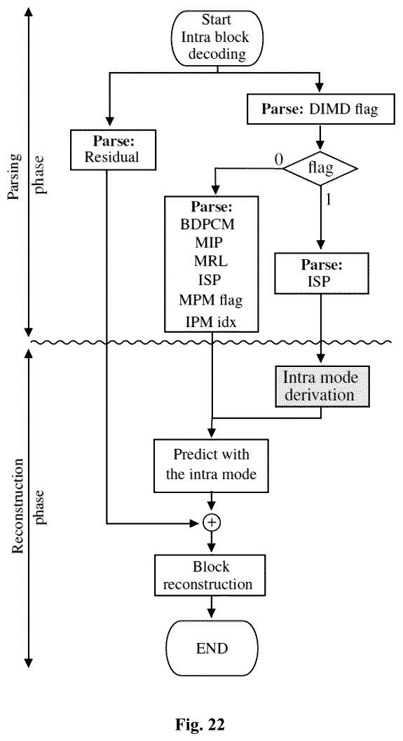

FIG. 22 shows the order of parsing flags/indices in VTM5, integrated with the proposed DIMD.

As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR_IDX is used as the virtual IPM of the DIMD block.

### 2.7.2. Texture Analysis

The texture analysis of DIMD includes a Histogram of Gradient (HoG) computation (FIG. 23). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 23.

In addition to reduction in the number of operations for gradient computation, this property also simplifies the selection of best 2 modes from the HoG, as the resulting HoG cannot have more than two non-zero amplitudes.

### 2.7.3. Prediction Fusion

Like the previous version, the current version of the method also uses a fusion of three predictors for each block. However, the choice of prediction modes is different and makes use of the combined hypothesis intra-prediction method, where the Planar mode is considered to be used in combination with other modes when computing an intra-predicted candidate. In the current version, the two IPMs corresponding to two tallest HoG bars are combined with the Planar mode.

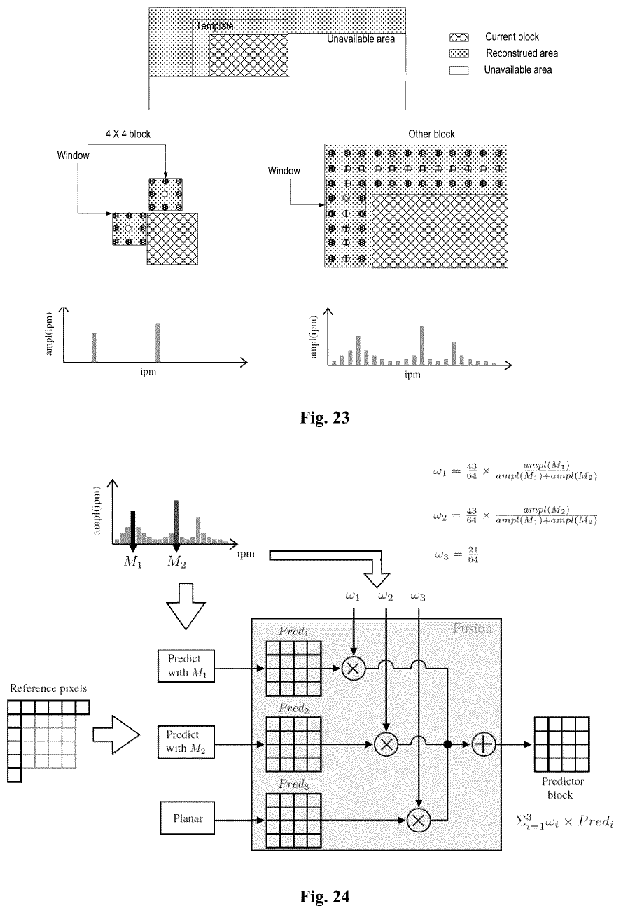

The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 24 visualises this process.

### 2.8. DIMD

When DIMD is applied, two intra modes are derived from the reconstructed neighbor samples, and those two predictors are combined with the planar mode predictor with the weights derived from the gradients as described in Section 2.7.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 3. PROBLEMS

In hardware design, inter-blocks and intra-blocks are reconstructed in two stages. However, inter-prediction relying on neighboring reconstruction samples, such as template-matching based MV derivation, template-matching based merge list reconstruction or LIC, may impose dependency of the two stages, which may bring an undesirable latency.

In addition, the template-matching based method applied to intra coded blocks may increase the pipeline delay as well.

Coding tools/features that require an inter frame accessing reconstructed neighbor samples would cause data dependency issue, which may break/destroy the decoder pipeline architecture.

### 4. EMBODIMENTS OF THE PRESENT DISCLOSURE

The detailed disclosure below should be considered as examples or embodiments to explain general concepts. These examples should not be interpreted in a narrow way. Furthermore, these examples can be combined in any manner.

The term ‘block’ may represent a coding block (CB), a CU, a PU, a TU, a PB, a TB.

In the following discussion, a “template-based-coded” block may refer to a block using a template-based method in the coding/decoding process to derive or refined coded information, such as template-matching based MV derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, Combined Inter-Intra Prediction (CIIP), FRUC, BDOF, DMVR, OBMC, etc. In yet another example, the “template-based-coded” block may also refer to a block which derive or refine its decoded information based on certain rules using neighboring reconstructed samples (adjacent or non-adjacent), e.g., the DIMD method in Section 2.7).

1. In one example, how to and/or whether to use a first piece of motion information (may comprising MV, reference index, reference list, weighting values, BCW index, parameters of a and b in LIC, etc.) of a first block to code a second piece of motion information of a second block may depend on whether the first block is template-based-coded.
1) In one example, the second block may be in the same picture or slice/tile/subpicture as the first block.
2) In one example, the second block may be in a different picture or slice/tile/subpicture to the first block.
3) In one example, the first piece of motion information of the first block cannot be used to code the second piece of motion information of the second block if the first block is template-based-coded.
   a) In one example, the first block may be marked as unavailable or intra-coded when coding/decoding the second block, if the first block is template-based-coded.
   b) In one example, the motion information of first block may be set to some default values (such as MV equal to zero) when coding/decoding the second block, if the first block is template-based-coded.
4) In one example, a third piece of motion information of the first block may be used to code the second piece of motion information of the second block if the first block is template-based-coded, wherein the third piece of motion information of the first block is the motion information that is obtained before the template-based process.
   a) In one example, the third piece instead of the first piece of motion information of the first block may be stored for the first block.
   b) In one example, the third piece and the first piece of motion information of the first block may be both stored for the first block.
   c) Furthermore, the third piece instead of the first piece of motion information of the first block may be used for a second block's spatial motion vector prediction, such as merge candidate, AMVP candidate, HMVP table, and so on.
5) In one example, if a first block is template-based-coded, the motion information of the first block may be only used for (a) motion compensation to generate the inter prediction for the first block, and (b) temporal motion vector prediction for a second block.

2. In one example, how to and/or whether to use a first piece of motion information (may comprising MV, reference index, reference list, weighting values, BCW index, parameters of a and b in LIC, etc.) of a first block in the deblocking filtering may depend on whether the first block is template-based-coded.
1) In one example, the first piece of motion information of the first block cannot be used in the deblocking filtering if the first block is template-based-coded.
   a) In one example, the first block may be marked as unavailable or intra-coded in the deblocking filtering, if the first block is template-based-coded.
   b) In one example, the motion information of first block may be set to some default values (such as MV equal to zero) in the deblocking filtering, if the first block is template-based-coded.
2) In one example, a third piece of motion information of the first block may be used in the deblocking filtering if the first block is template-based-coded, wherein the third piece of motion information of the first block is the motion information that is obtained before the template-based process.
   a) In one example, the third piece instead of the first piece of motion information of the first block may be stored for the first block.
   b) In one example, the third piece and the first piece of motion information of the first block may be both stored for the first block.

3. In above bullets, the statement of “first piece of motion information” may be replaced by any other coded information that is derived or refined by a template-based method.
1) In one example, the first piece of motion information may be replaced by an intra prediction mode.
   a) In one example, for a first block coded with the DIMD mode wherein the intra prediction mode is derived according to a template or other rules (e.g., described in section 2.7), the derived intra prediction mode is disallowed to be used during the coding/decoding of a second block in current slice/tile/subpicture/picture or during the deblocking filter process.
      a. Instead of including all the derived intra prediction modes in the primary list of intra most probable modes (MPM), it is proposed that one or more derived intra prediction modes are not included in the MPM list.
         a) In one example, the one or more derived intra prediction modes may be derived using the neighboring reconstructed samples of current block.
         i. In one example, the derived intra prediction modes may be derived using the same method as in Section 2.7 and 2.8.
         b) In one example, the MPM list may refer to the primary MPM list and/or the secondary MPM list.
         c) Alternatively, it is proposed to include one or more derived intra prediction modes in the secondary MPM list.
      b. Alternatively, it is proposed to include the partial of the derived intra prediction modes in the primary and/or secondary MPM list.
   b) In one example, for a first IBC-coded block with the template-based mode wherein its block vector is derived/refined according to a template or other rules, the derived or refined block vector is disallowed to be used during the coding/decoding of a second block in current slice/tile/subpicture/picture or during the deblocking filter process.

4. For example, whether to and/or how to apply a template-based process on a block may depend on the coding information of the block. The information of the block may comprise (one of or any combination of):
1) Width and/or height of the block.
2) Size of the block.
3) Coding tree depth of the block
4) Coding mode of the block
5) Prediction direction of the block, e.g., uni-prediction or bi-prediction
6) Reference information of the block, e.g., reference indexes, reference availability, POC distances, and etc.
7) Texture characteristic of the block, e.g., whether it is screen content.

5. For example, whether to and/or how to apply a template-based process on a first block may depend on the coding information of at least one neighboring block (namely a second block) of the first block. The information of the second block may comprise (one of or any combination of):
1) Width and/or height of the second block.
2) Size of the second block.
3) Coding tree depth of the second block
4) Coding mode of the second block.
5) Availability of the second block
6) In one example, above neighboring samples cannot be included in the template if the above neighboring block (namely the second block) covering the above neighboring samples satisfies or not satisfies one or multiple conditions.
   a) In one example, above neighboring samples cannot be included in the template if the above neighboring block (namely the second block) covering the above neighboring samples with intra/IBC coding mode.
7) In one example, left neighboring samples cannot be included in the template if the left neighboring block (namely the second block) covering the left neighboring samples satisfies or not satisfies one or multiple conditions.
   a) In one example, left neighboring samples cannot be included in the template if the left neighboring block (namely the second block) covering the left neighboring samples with intra/IBC coding mode.
8) The one or multiple conditions may comprise (one of or any combination of):
   a) The second block is inter-coded.
   b) The second block is intra-coded.
   c) The second block is IBC-coded.
   d) The residues of the second block are equal to zero (e.g., coded block flag (cbf) of the second block is equal to zero)
   e) The residues of the second block are not equal to zero (e.g., cbf of the second block is not equal to zero)
   f) The second block is template-based-coded.
   g) The second block is not template-based-coded.

6. For example, prediction samples instead of reconstruction samples of a neighboring block may be used to obtain the template for a template-based-coded block.
1) In one example, prediction samples of a neighboring block may be used to obtain the template for an inter coded block.
2) In one example, prediction samples of a neighboring block may be used to obtain the template for an intra coded block.
3) In one example, prediction samples of a neighboring block may be used to obtain the template for an intra block copy coded block.
4) In one example, prediction samples of a neighboring block may be used to obtain the template for a palette coded block.

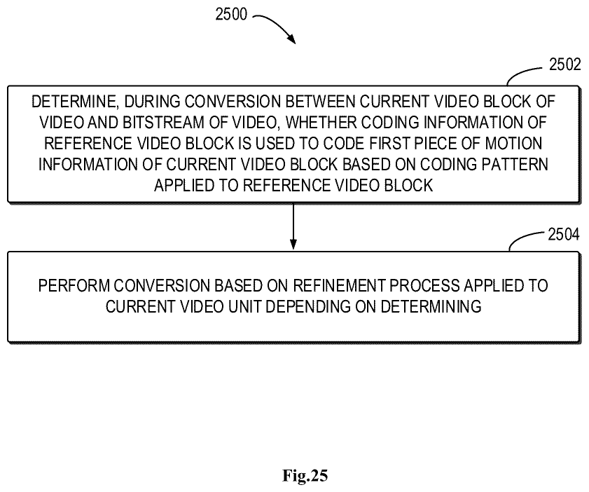

FIG. 25 illustrates a flowchart of a method 2500 for video processing in accordance with some embodiments of the present disclosure. As shown in FIG. 25, at 2502, during a conversion between a current video block of a video and a bitstream of the video, it is determined whether coding information of a reference video block is used to code a first piece of motion information of the current video block based on a coding pattern applied to the reference video block. At 2504, the conversion is performed based on the determining at 2502.

According to the method 2500, whether to or how to code a first piece of motion information of the current video block may depend on the coding information of a reference video block such as motion information or any other coding information derived or refined by a template-based method. Therefore, the coding process based on the proposed solution is more efficiency. Compared with the conventional solution, the method 2500 in accordance with some embodiments of the present disclosure can advantageously avoid the undesired latency and improve the coding performance and efficiency.

In some embodiments, the coding information comprises a second piece of motion information of the reference video block or coding information derived or refined by a template-based mode.

In some embodiments, the second piece of motion information of the reference video block may comprise at least one of MV, reference index, reference list, weighting values, BCW index, parameters of a and b in LIC, etc.

In some embodiments, the current video block may be in the same picture, slice, tile, or subpicture as the reference video block.

In some embodiments, the current video block may be in the different picture, slice, tile, or subpicture as the reference video block.

In some embodiments, if the reference video block is template-based-coded, the second piece of the motion information of the reference video block is not used for coding the first piece of the motion information of the current video block.

In some embodiments, if the reference video block is template-based-coded. the reference video block may be marked as unavailable or intra-coded during a coding process of the current video block or a decoding process of the current video block.

In some embodiments, if the reference video block is template-based-coded, the motion information of the reference video block may be set to one or more default values, such as MV equal to zero, during a coding process of the current video block or a decoding process of the current video block.

In some embodiments, if the reference video block is template-based-coded, a third piece of motion information of the reference video block may be used to code the motion information of the current video block, wherein the third piece of motion information of the reference video block is the motion information that is obtained before the template-based process.

In some embodiments, the third piece instead of the second piece of motion information of the reference video block may be stored for the reference video block.

In some embodiments, the third and the first pieces of motion information of the reference video block may be both stored for the reference video block.

In some embodiments, the third piece instead of the second piece of motion information of the reference video block may be used for spatial motion vector prediction of the current video block. For example, the spatial motion vector prediction of the current video block may comprise at least one of as a merge candidate, an advanced motion vector predication (AMVP) candidate, a history-based motion vector predication (HMVP) table, and so on.

In some embodiments, how to and/or whether to use the second piece of motion information of the reference video block in the deblocking filtering may depend on whether the reference video block is template-based-coded.

In some embodiments, if the reference video block is template-based-coded, the second piece of the motion information of the reference video block is not used in the deblocking filtering.

In some embodiments, if the reference video block is template-based-coded, the reference video block may be marked as unavailable or intra-coded in the deblocking filtering.

In some embodiments, if the reference video block is template-based-coded, the motion information of the reference video block may be set to one or more default values, such as MV equal to zero, in the deblocking filtering.

In some embodiments, if the reference video block is template-based-coded, a third piece of the motion information of the reference video block may be used in the deblocking filtering, and wherein the third piece is obtained before the template-based coding process.

In some embodiments, if the reference video block is template-based-coded, the third piece of the motion information instead of the second piece of the motion information may be stored for the reference video block.

In some embodiments, the coding information derived or refined by a template-based mode may refer to an intra prediction mode.

In some embodiments, for the reference video block coded with the decoder-side intra mode derivation mode (DIMD), a derived intra prediction mode may be disallowed to be used during a coding process of the current video block in current slice, tile, subpicture or picture, a decoding process of the current video block in in current slice, tile, subpicture or picture, or a deblocking filter process.

In some embodiments, the intra prediction mode may be derived according to a template process or a DIMD process as described above in Section 2.7.

In some embodiments, instead of including all the derived intra prediction modes in the primary list of intra most probable modes (MPM), one or more derived intra prediction modes are not included in the MPM list.

In some embodiments, the one or more derived intra prediction modes may be derived by using the neighboring reconstructed samples of current video block. For example, the derived intra prediction modes may be derived using the same method as in Section 2.7 and 2.8.

In some embodiments, the MPM list may refer to the primary MPM list and/or the secondary MPM list.

In some embodiment, one or more derived intra prediction modes are included in the secondary MPM list.

In some embodiment, a partial of derived intra prediction modes are included in a primary MPM list or a secondary MPM list.

In some embodiment, for the reference video block coded with intra block copy (IBC) with the template-based mode, a derived reference video block or a refined reference video block is disallowed to be used during a coding process of the current video block in current slice, tile, subpicture or picture, a decoding process of the current video block in in current slice, tile, subpicture or picture, or a deblocking filter process.

In some embodiments, the reference video block may be derived or refined according to a template process or other suitable rules.

In some embodiments, the conversion at 2504 may comprise decoding the target picture from the bitstream of the video

In some embodiments, the conversion at 2504 may comprise encoding the target picture into the bitstream of the video.

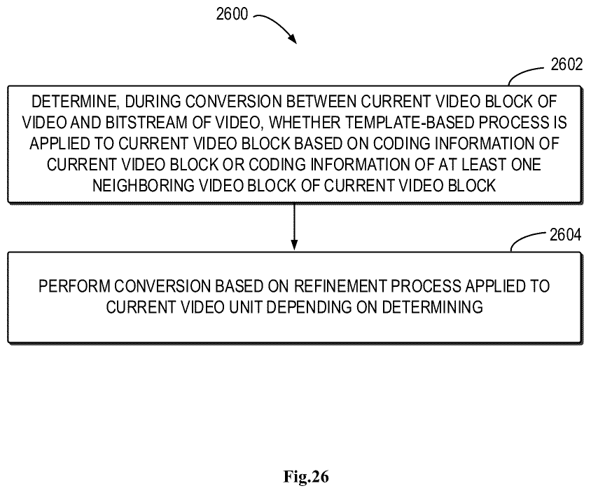

FIG. 26 illustrates a flowchart of a method 2600 for video processing in accordance with some embodiments of the present disclosure. As shown in FIG. 26, the method 2600 starts at 2602, where during a conversion between a current video block of a video and a bitstream of the video, it is determined whether a template-based process is applied to the current video block based on coding information of the current video block or coding information of at least one neighboring video block of the current video block. At 2604, the conversion is performed based on the determining at 2602.

According to the method 2600, whether to or how to apply a template-based process on the current video block may depend on the coding information of the current video block or reference video block, such as at least one neighboring video block. Therefore, the coding process based on the proposed solution is more efficiency. Compared with the conventional solution, the method 2600 in accordance with some embodiments of the present disclosure can advantageously avoid the undesired latency and improve the coding performance and efficiency.

In some embodiments, the coding information of the current video block comprises at least one of a width of the current video block, a height of the current video block, a size of the current video block, a coding tree depth of the current video block, a coding mode of the current video block; a prediction direction of the current video block, a reference information of the current video block, or a texture characteristic of the current video block.

In some embodiments, the coding information of the at least one neighboring video block comprises at least one of respective widths of the at least one neighboring video block, respective heights of the at least one neighboring video block, respective sizes of the at least one neighboring video block, respective coding tree depths of the at least one neighboring video block, or respective coding modes of the at least one neighboring video block.

In some embodiments, if a neighboring block above the current video block satisfies one or more predefined conditions, above neighboring samples covered by the neighboring block above the current video block are not included in a template of the template-based process.

In some embodiments, the above neighboring samples cannot be included in the template if the above neighboring block covering the above neighboring samples with intra/IBC coding mode.

For example, the one or more predefined conditions may comprise at least one of the at least one neighboring video block is inter-coded; the at least one neighboring video block is intra-coded; the at least one neighboring video block is intra block copy (IBC)-coded; residues of the at least one neighboring video block are equal to zero; residues of the at least one neighboring video block are not equal to zero; the at least one neighboring video block is template-based-coded; or the at least one neighboring video block is not template-based-coded. For example, residues of the at least one neighboring video block are equal to zero may refer to cbf of the at least one neighboring video block is equal to zero. For example, residues of the at least one neighboring video block are not equal to zero may refer to cbf of the at least one neighboring video block is not equal to zero.

In some embodiments, if a neighboring block located in the left of the current video block satisfies one or more predefined conditions, left neighboring samples covered by the neighboring block in the left of the current video block are not included in a template of the template-based process.

In one example, the left neighboring samples cannot be included in the template if the left neighboring block covering the left neighboring samples with intra/IBC coding mode.

For example, the one or more predefined conditions may comprise at least one of the at least one neighboring video block is inter-coded; the at least one neighboring video block is intra-coded; the at least one neighboring video block is intra block copy (IBC)-coded; residues of the at least one neighboring video block are equal to zero; residues of the at least one neighboring video block are not equal to zero; the at least one neighboring video block is template-based-coded; or the at least one neighboring video block is not template-based-coded. For example, residues of the at least one neighboring video block are equal to zero may refer to cbf of the at least one neighboring video block is equal to zero. For example, residues of the at least one neighboring video block are not equal to zero may refer to cbf of the at least one neighboring video block is not equal to zero.

In some embodiments, prediction samples of a neighboring video block are used to obtain a template for a template-based-coded block.

In some embodiments, prediction samples of the neighboring block may be used to obtain the template for an inter coded block.

In some embodiments, prediction samples of the neighboring block may be used to obtain the template for an intra coded block.

In some embodiments, prediction samples of the neighboring block may be used to obtain the template for an intra block copy coded block.

In some embodiments, prediction samples of the neighboring block may be used to obtain the template for a palette coded block.

In some embodiments, the conversion at 2604 may comprise decoding the target picture from the bitstream of the video

In some embodiments, the conversion at 2604 may comprise encoding the target picture into the bitstream of the video.

Implementations of the present disclosure can be described in view of the following clauses, the features of which can be combined in any reasonable manner.

Clause 1. A method for video processing comprising determining, during a conversion between a current video block of a video and a bitstream of the video, whether coded information of a reference video block is used to code a first piece of motion information of the current video block based on a coding pattern applied to the reference video block; and performing the conversion based on the determining.

Clause 2. The method of clause 1, wherein the coding information comprises one of: a second piece of motion information of the reference video block, or coding information derived or refined by a template-based mode.

Clause 3. The method of clause 1 or 2, wherein the current video block is in the same picture, slice, tile, or subpicture as the reference video block.

Clause 4. The method of clause 1 or 2, wherein the current video block is in the different picture, slice, tile, or subpicture as the reference video block.

Clause 5. The method of clause 2, determining whether the coding information of the reference video block is used comprises: in response to that the reference video block is template-based-coded, determining that the second piece of the motion information of the reference video block is not used for coding the first piece of the motion information of the current video block.

Clause 6. The method of clause 5, wherein the reference video block is marked as unavailable or intra-coded during a coding process of the current video block or a decoding process of the current video block.

Clause 7. The method of clause 5, wherein the motion information of the reference video block is set to one or more default values during a coding process of the current video block or a decoding process of the current video block.

Clause 8. The method of clause 5, further comprising: coding the first piece of the motion information of the current video block by using a third piece of the motion information of the reference video block, wherein the third piece is obtained before the template-based coding process.

Clause 9. The method of clause 8, wherein the third piece of the motion information instead of the second piece of the motion information is stored for the reference video block.

Clause 10. The method of clause 8, wherein the third piece of the motion information instead of the second piece of the motion information may be used for a spatial motion vector prediction of the current video block.

Clause 11. The method of clause 10, herein the spatial motion vector prediction comprises at least one of the following: a merge candidate, an advanced motion vector predication, or a history-based motion vector predication table.

Clause 12. The method of clause 2, whether the second piece of the motion information of the reference video block is used to code the first piece of the motion information of the current video block in a deblocking filtering is determined based on the coding pattern applied to the reference video block.

Clause 13. The method of clause 12, wherein the second piece of the motion information of the reference video block is not used in the deblocking filtering if the reference video block is template-based-coded.

Clause 14. The method of clause 13, wherein the reference video block is marked as unavailable or intra-coded in the deblocking filtering.

Clause 15. The method of clause 13, wherein the motion information of the reference video block is set to one or more default values in the deblocking filtering.

Clause 16. The method of clause 13, wherein a third piece of the motion information of the reference video block is used in the deblocking filtering, and wherein the third piece is obtained before the template-based coding process.

Clause 17. The method of clause 16, wherein the third piece of the motion information instead of the second piece of the motion information is stored for the reference video block.

Clause 18. The method of any of clause 2 or 17, wherein the second piece of motion information comprises at least one of: a motion vector, a reference index, a reference list, weighting values, or parameters of a and b in local illumination compensation (LIC).

Clause 19. The method of clause 2, wherein the coding information derived or refined by a template-based mode comprises an intra prediction mode.

Clause 20. The method of clause 19, wherein for the reference video block coded with the decoder-side intra mode derivation mode (DIMD), a derived intra prediction mode is disallowed to be used during at least one of the following: a coding process of the current video block in current slice, tile, subpicture or picture, a decoding process of the current video block in in current slice, tile, subpicture or picture, or a deblocking filter process.

Clause 21. The method of clause 20, wherein the intra prediction mode is derived according to a template process or a DIMD process.

Clause 22. The method of clause 20, wherein one or more derived intra prediction modes are not included in a most probable modes (MPM) list.

Clause 23. The method of clause 22, wherein the one or more derived intra prediction modes are derived by using the neighboring reconstructed samples of current video block.

Clause 24. The method of clause 22, wherein the MPM list comprises at least one of a primary MPM list or a secondary MPM list.

Clause 25. The method of clause 24, wherein one or more derived intra prediction modes are included in the secondary MPM list.

Clause 26. The method of clause 20, wherein a partial of derived intra prediction modes are included in a primary MPM list or a secondary MPM list.

Clause 27. The method of clause 19, wherein for the reference video block coded with intra block copy (IBC) with the template-based mode, a derived reference video block or a refined reference video block is disallowed to be used during at least one of the following: a coding process of the current video block in current slice, tile, subpicture or picture, a decoding process of the current video block in in current slice, tile, subpicture or picture, or a deblocking filter process.

Clause 28. The method of clause 27, wherein the reference video block is derived or refined according to a template process.

Clause 29. The method of any of clause 1-28, wherein the conversion comprises decoding the current video block from the bitstream of the video.

Clause 30. The method of any of clause 1-28, wherein the conversion comprises encoding the current video block into the bitstream of the video.

Clause 31. A method for video processing, comprising: determining, during a conversion between a current video block of a video and a bitstream of the video, whether a template-based process is applied to the current video block based on coding information of the current video block or coding information of at least one neighboring video block of the current video block; and performing the conversion based on the determining.

Clause 32. The method of clause 31, wherein the coding information of the current video block comprises at least one of the following: a width of the current video block, a height of the current video block, a size of the current video block, a coding tree depth of the current video block, a coding mode of the current video block; a prediction direction of the current video block, a reference information of the current video block, or a texture characteristic of the current video block.

Clause 33. The method of clause 31, wherein the coding information of the at least one neighboring video block comprises at least one of the following: respective widths of the at least one neighboring video block, respective heights of the at least one neighboring video block, respective sizes of the at least one neighboring video block, respective coding tree depths of the at least one neighboring video block, or respective coding modes of the at least one neighboring video block.

Clause 34. The method of clause 31, wherein if a neighboring block above the current video block satisfies one or more predefined conditions, above neighboring samples covered by the neighboring block above the current video block are not included in a template of the template-based process.

Clause 35. The method of clause 31, wherein if a neighboring block located in the left of the current video block satisfies one or more predefined conditions, left neighboring samples covered by the neighboring block in the left of the current video block are not included in a template of the template-based process.

Clause 36. The method of clause 34 or 35, wherein the one or more predefined conditions comprises at least one of the following: the at least one neighboring video block is inter-coded; the at least one neighboring video block is intra-coded; the at least one neighboring video block is intra block copy (IBC)-coded; residues of the at least one neighboring video block are equal to zero; residues of the at least one neighboring video block are not equal to zero; the at least one neighboring video block is template-based-coded; or the at least one neighboring video block is not template-based-coded.

Clause 37. The method of clause 31, wherein prediction samples of a neighboring video block are used to obtain a template for a template-based-coded block.

Clause 38. The method of clause 37, wherein prediction samples of the neighboring video block are used to obtain the template for at least one of the following: an inter coded block, an intra coded block, an intra block copy coded block, or a palette coded block.

Clause 39. The method of any of clauses 31-38, wherein the conversion comprises decoding the current video block from the bitstream of the video.

Clause 40. The method of any of clauses 31-38, wherein the conversion comprises encoding the current video block into the bitstream of the video.

Clause 41. An apparatus for processing video data comprising a processor and a non-transitory memory with instructions thereon, wherein the instructions upon execution by the processor, cause the processor to perform a method in accordance with any of clauses 1-30 or any of clauses 31-40.

Clause 42. A non-transitory computer-readable storage medium storing instructions that cause a processor to perform a method in accordance with any of clauses 1-30 or any of clauses 31-40.

Clause 43. A non-transitory computer-readable recording medium storing a bitstream of a video which is generated by a method performed by a video processing apparatus, wherein the method comprises: determining whether coding information of a reference video block is used to code a first piece of motion information of the current video block based on a coding pattern applied to the reference video block; and generating the bitstream based on the determining.

Clause 44. A method for storing bitstream of a video comprising: determining whether coding information of a reference video block is used to code a first piece of motion information of the current video block based on a coding pattern applied to the reference video block; generating the bitstream based on the determining; and storing the bitstream in a non-transitory computer-readable recording medium.

Clause 45. A non-transitory computer-readable recording medium storing a bitstream of a video which is generated by a method performed by a video processing apparatus, wherein the method comprises: determining whether a template-based process is to be applied to the current video block based on coding information of the current video block or coding information of at least one neighboring video block of the current video block; and generating the bitstream based on the determining.

Clause 46. A method for storing bitstream of a video comprising: determining whether a template-based process is to be applied to the current video block based on coding information of the current video block or coding information of at least one neighboring video block of the current video block; generating the bitstream based on the determining; and storing the bitstream in a non-transitory computer-readable recording medium.

### Example Device

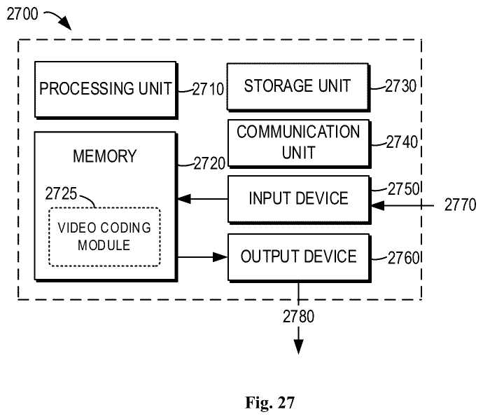

FIG. 27 illustrates a block diagram of a computing device 2700 in which various embodiments of the present disclosure can be implemented. The computing device 2700 may be implemented as or included in the source device 110 (or the video encoder 114 or 200) or the destination device 120 (or the video decoder 124 or 300).

It would be appreciated that the computing device 2700 shown in FIG. 27 is merely for purpose of illustration, without suggesting any limitation to the functions and scopes of the embodiments of the present disclosure in any manner.

As shown in FIG. 27, the computing device 2700 includes a general-purpose computing device 2700. The computing device 2700 may at least comprise one or more processors or processing units 2710, a memory 2720, a storage unit 2730, one or more communication units 2740, one or more input devices 2750, and one or more output devices 2760.

In some embodiments, the computing device 2700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2700 can support any type of interface to a user (such as “wearable” circuitry and the like).

The processing unit 2710 may be a physical or virtual processor and can implement various processes based on programs stored in the memory 2720. In a multi-processor system, multiple processing units execute computer executable instructions in parallel so as to improve the parallel processing capability of the computing device 2700. The processing unit 2710 may also be referred to as a central processing unit (CPU), a microprocessor, a controller or a microcontroller.

The computing device 2700 typically includes various computer storage medium. Such medium can be any medium accessible by the computing device 2700, including, but not limited to, volatile and non-volatile medium, or detachable and non-detachable medium. The memory 2720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2730 may be any detachable or non-detachable medium and may include a machine-readable medium such as a memory, flash memory drive, magnetic disk or another other media, which can be used for storing information and/or data and can be accessed in the computing device 2700.

The computing device 2700 may further include additional detachable/non-detachable, volatile/non-volatile memory medium. Although not shown in FIG. 27, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2740 communicates with a further computing device via the communication medium. In addition, the functions of the components in the computing device 2700 can be implemented by a single computing cluster or multiple computing machines that can communicate via communication connections. Therefore, the computing device 2700 can operate in a networked environment using a logical connection with one or more other servers, networked personal computers (PCs) or further general network nodes.

The input device 2750 may be one or more of a variety of input devices, such as a mouse, keyboard, tracking ball, voice-input device, and the like. The output device 2760 may be one or more of a variety of output devices, such as a display, loudspeaker, printer, and the like. By means of the communication unit 2740, the computing device 2700 can further communicate with one or more external devices (not shown) such as the storage devices and display device, with one or more devices enabling the user to interact with the computing device 2700, or any devices (such as a network card, a modem and the like) enabling the computing device 2700 to communicate with one or more other computing devices, if required. Such communication can be performed via input/output (I/O) interfaces (not shown).

In some embodiments, instead of being integrated in a single device, some or all components of the computing device 2700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2700 may be used to implement video encoding/decoding in embodiments of the present disclosure. The memory 2720 may include one or more video coding modules 2725 having one or more program instructions. These modules are accessible and executable by the processing unit 2710 to perform the functionalities of the various embodiments described herein.

In the example embodiments of performing video encoding, the input device 2750 may receive video data as an input 2770 to be encoded. The video data may be processed, for example, by the video coding module 2725, to generate an encoded bitstream. The encoded bitstream may be provided via the output device 2760 as an output 2780.

In the example embodiments of performing video decoding, the input device 2750 may receive an encoded bitstream as the input 2770. The encoded bitstream may be processed, for example, by the video coding module 2725, to generate decoded video data. The decoded video data may be provided via the output device 2760 as the output 2780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1.-46. (canceled)

47. A method for video processing, comprising:
determining, during a conversion between a current video block of a video and a bitstream of the video, one of the following:
whether coded information of a reference video block is used to code a first piece of motion information of the current video block based on a coding pattern applied to the reference video block, or
whether a template-based process is applied to the current video block based on coding information of the current video block or coding information of at least one neighboring video block of the current video block; and
performing the conversion based on the determining.

48. The method of claim 47, wherein the coding information comprises one of: a second piece of motion information of the reference video block, or coding information derived or refined by a template-based mode, or
wherein the current video block is in the same picture, slice, tile, or subpicture as the reference video block, or
wherein the current video block is in the different picture, slice, tile, or subpicture as the reference video block.

49. The method of claim 48, wherein determining whether the coding information of the reference video block is used comprises:
in response to that the reference video block is template-based-coded, determining that the second piece of the motion information of the reference video block is not used for coding the first piece of the motion information of the current video block.

50. The method of claim 49, wherein the reference video block is marked as unavailable or intra-coded during a coding process of the current video block or a decoding process of the current video block, or
wherein the motion information of the reference video block is set to one or more default values during a coding process of the current video block or a decoding process of the current video block, or
wherein the method further comprises: coding the first piece of the motion information of the current video block by using a third piece of the motion information of the reference video block, wherein the third piece is obtained before the template-based coding process.

51. The method of claim 48, wherein whether the second piece of the motion information of the reference video block is used to code the first piece of the motion information of the current video block in a deblocking filtering is determined based on the coding pattern applied to the reference video block.

52. The method of claim 51, wherein the second piece of the motion information of the reference video block is not used in the deblocking filtering if the reference video block is template-based-coded.

53. The method of claim 52, wherein the reference video block is marked as unavailable or intra-coded in the deblocking filtering, or
wherein the motion information of the reference video block is set to one or more default values in the deblocking filtering, or
wherein a third piece of the motion information of the reference video block is used in the deblocking filtering, and wherein the third piece is obtained before the template-based coding process.

54. The method of claim 53, wherein the third piece of the motion information instead of the second piece of the motion information is stored for the reference video block.

55. The method of claim 48, wherein the second piece of motion information comprises at least one of:
a motion vector,
a reference index,
a reference list,
weighting values, or
parameters of a and b in local illumination compensation (LIC), or
wherein the coding information derived or refined by a template-based mode comprises an intra prediction mode.

56. The method of claim 55, wherein for the reference video block coded with the decoder-side intra mode derivation mode (DIMD), a derived intra prediction mode is disallowed to be used during at least one of the following:
a coding process of the current video block in current slice, tile, subpicture or picture,
a decoding process of the current video block in in current slice, tile, subpicture or picture, or
a deblocking filter process.

57. The method of claim 56, wherein the intra prediction mode is derived according to a template process or a DIMD process, or
wherein one or more derived intra prediction modes are not included in a most probable modes (MPM) list.

58. The method of claim 57, wherein the one or more derived intra prediction modes are derived by using the neighboring reconstructed samples of current video block, or wherein the MPM list comprises at least one of a primary MPM list or a secondary MPM list.

59. The method of claim 56, wherein a partial of derived intra prediction modes are included in a primary MPM list or a secondary MPM list.

60. The method of claim 55, wherein for the reference video block coded with intra block copy (IBC) with the template-based mode, a derived reference video block or a refined reference video block is disallowed to be used during at least one of the following:
a coding process of the current video block in current slice, tile, subpicture or picture,
a decoding process of the current video block in in current slice, tile, subpicture or picture, or
a deblocking filter process.

61. The method of claim 60, wherein the reference video block is derived or refined according to a template process.

62. The method of claim 47, wherein the coding information of the current video block comprises at least one of the following:
a width of the current video block,
a height of the current video block,
a size of the current video block,
a coding tree depth of the current video block,
a coding mode of the current video block,
a prediction direction of the current video block,
a reference information of the current video block, or
a texture characteristic of the current video block, or
wherein the coding information of the at least one neighboring video block comprises at least one of the following:
respective widths of the at least one neighboring video block,
respective heights of the at least one neighboring video block,
respective sizes of the at least one neighboring video block,
respective coding tree depths of the at least one neighboring video block, or
respective coding modes of the at least one neighboring video block, or
wherein if a neighboring block above the current video block satisfies one or more predefined conditions, above neighboring samples covered by the neighboring block above the current video block are not included in a template of the template-based process, or
wherein if a neighboring block located in the left of the current video block satisfies one or more predefined conditions, left neighboring samples covered by the neighboring block in the left of the current video block are not included in a template of the template-based process, or
wherein prediction samples of a neighboring video block are used to obtain a template for a template-based-coded block.

63. The method of claim 62, wherein the one or more predefined conditions comprises at least one of the following:
the at least one neighboring video block is inter-coded;
the at least one neighboring video block is intra-coded;
the at least one neighboring video block is intra block copy (IBC)-coded;
residues of the at least one neighboring video block are equal to zero;
residues of the at least one neighboring video block are not equal to zero;
the at least one neighboring video block is template-based-coded; or
the at least one neighboring video block is not template-based-coded, or
wherein prediction samples of the neighboring video block are used to obtain the template for at least one of the following:
an inter coded block,
an intra coded block,
an intra block copy coded block, or
a palette coded block.

64. The method of claim 47, wherein the conversion comprises decoding the current video block from the bitstream of the video, or
wherein the conversion comprises encoding the current video block into the bitstream of the video.

65. An apparatus for processing video data comprising a processor and a non-transitory memory with instructions thereon, wherein the instructions upon execution by the processor, cause the processor to perform a method comprising:
determining, during a conversion between a current video block of a video and a bitstream of the video, one of the following:
whether coded information of a reference video block is used to code a first piece of motion information of the current video block based on a coding pattern applied to the reference video block, or
whether a template-based process is applied to the current video block based on coding information of the current video block or coding information of at least one neighboring video block of the current video block; and
performing the conversion based on the determining.

66. A non-transitory computer-readable storage medium storing instructions that cause a processor to perform a method comprising:
determining, during a conversion between a current video block of a video and a bitstream of the video, one of the following:
whether coded information of a reference video block is used to code a first piece of motion information of the current video block based on a coding pattern applied to the reference video block, or
whether a template-based process is applied to the current video block based on coding information of the current video block or coding information of at least one neighboring video block of the current video block; and
performing the conversion based on the determining.
